(19) United States
(12) Patent Application Publication
(10) Pub. No.: US 2023/0013537 A1
(43) Pub. Date: Jan. 19, 2023

(54) SUPERHARD MATERIAL-CONTAINING OBJECTS AND METHODS OF PRODUCTION THEREOF

(71) Applicant: International Diamond Services, Inc., Houston, TX (US)

(72) Inventor: RAMAMURTHY K VISWANADHAM, Spring, TX (US)

(21) Appl. No.: 17/865,011

(22) Filed: Jul. 14, 2022

Related U.S. Application Data
(60) Provisional application No. 63/221,777, filed on Jul. 14, 2021.

(51) Int. Cl. B28B 1/00; B33Y 10/00; B33Y 80/00; B29C 64/118; B33Y 40/20; B33Y 70/10

(52) U.S. Cl. CPC B28B 1/001; B33Y 10/00; B33Y 80/00; B29C 64/118; B33Y 40/20; B33Y 70/10

(57) ABSTRACT

A superhard material-containing object is configured to have a controlled and repeatable three-dimensional geometry and/or shape. The object further includes a desired three-dimensional spatial variation in microstructure, grain size and/or composition. The superhard material is selected from the group consisting of diamond, boron-doped diamond and cubic boron nitride. A process for production of a superhard material-containing object from a powder of a superhard material, a binder and an optional additive, includes the steps of: (a) producing a feedstock of the superhard material and a polymer binder; (b) extruding one or more filaments from a granulated superhard material-binder feedstock; (c) preparing a printed superhard material-containing object using the one or more filaments; (d) subjecting the printed object to debinding to prepare a debindered object; and (e) sintering the debindered printed object to produce the superhard material-containing object.

### CROSS-REFERENCE TO RELATED APPLICATION

This application claims the benefit of Provisional U.S. Patent Application No. 63/221,777, filed Jul. 14, 2021, entitled “POLYMER ASSISTED PRODUCTION OF DIAMOND BASED COMPOSITES”, the entire content and disclosure of which, both express and implied, is incorporated herein by reference.

### BACKGROUND

A superhard material is a material with extremely high hardness. Superhard materials and their products and tools have been widely used in industry. Superhard materials include diamonds and cubic boron nitride. Diamond based composites (DBCs), owing to their superior properties like exceptional hardness, high Young's modulus and other similar properties, have gained significant popularity across a gamut of application areas, including, for cutting, milling, grinding, drilling and such other abrasive operations, for thermal management in high-power integrated circuits, high power laser diodes, LED packages and similar applications, for electrochemical reactions, and other applications.

Polycrystalline diamond (PCD) cutters have emerged as the dominant cutter in oil drilling bits due to continuous improvements in cutters, substrates, interface design, brazing techniques, bit design, bit hydraulics and drill string dynamics amongst others. Currently, more than 80% of the total footage drilled is with fixed cutter drill bits using polycrystalline diamond cutters. Fairly early in the development of the PCD cutters, it was realized that the interface geometry between the diamond table and tungsten carbide cobalt (WC-Co) substrate can be manipulated to change the residual stress distribution and reduce the chances of delamination of the diamond table. Over the years, numerous interface geometries have been developed and used. These complex interface geometries introduce local variations in diamond powder packing and subsequent cobalt infiltration and distribution patterns. Like other hard material composites, an inverse relationship exists between wear resistance and fracture resistance in PCD composites. Variations in starting grain size and final applied pressure are used to increase one of these parameters at the expense of the other. Failure of the PCD cutters during drilling is primarily due to thermal damage, as diamond is inherently metastable at high temperature and degrades with increase in application temperature, especially in the oxidizing environment, which is typically present during the drilling. This is exacerbated by the difference in thermal expansion coefficients between diamond and the cobalt alloy binder. Consequently, there is a need for PCD cutters with more complex microstructures to minimize the compromise between wear resistance and impact strength.

Polycrystalline diamond (PCD) cutters are currently produced using manual placement of diamond powders in contact with a WC-Co composite substrate or by themselves in a refractory metal container, sealing it and subjecting the assembly to a high pressure high temperature (HPHT) process in a cubic anvil press or any suitable press capable of generating high pressures and temperatures. However, even for composites with a single dominant grain size, the manual placement creates variations in the final product. As the structure of the composite becomes more complex, for instance, by incorporating multiple grain sizes or diamonds/diamond powders of different composition in different areas of the composite, manual placement, even if feasible, produces uncontrolled variations, particularly, in layer thickness with position and subsequent leaching kinetics. Further, certain geometries such as a case/core structure where the case and core are different, either in grain size or in composition or both, become very difficult, if not impossible, to produce. Some geometries, such as a lattice structure, are nearly impossible to produce by conventional powder loading methods.

Diamond based composites, particularly, Diamond Particulate Composites (DPCs), having high thermal conductivity and a matching coefficient of thermal expansion, have recently been proposed to be used for thermal management in high-power integrated circuits, high power laser diodes, LED packages and similar applications. Conventionally, molten metal infiltration has been used for producing such composites. This process is typically carried out under conditions where the thermal stability of diamond may be compromised. Further, this process is expensive and types of geometries that can be produced are limited.

DBCs, such as porous Boron Doped Diamond (BDD) electrodes, have also received considerable scientific and research interest due to their very high over voltage and broad operating window for electrochemical reactions. Many reactions that conventionally could not be carried out on noble metals or other electrodes can be done with BDD electrodes. BDD electrodes are of two types: (i) Thin films made by chemical vapor deposition (CVD) wherein boron is incorporated from the gas phase as diboromethane, and (ii) polymeric electrodes, wherein BDD grit objects grown by a high pressure high temperature (HPHT) process are incorporated into a polymeric sheet. However, the current manufacturing techniques pose severe constraints on widespread commercial usage. Particularly, the CVD electrodes produced by conventional techniques are expensive, while the polymeric electrode can only be made in sheets by the conventional techniques.

### SUMMARY

According to an embodiment, an object comprising a superhard material is configured with desired controlled spatial variations in microstructure and/or composition. The object further includes a predetermined and repeatable three-dimensional geometry and/or shape. The superhard material can be selected from the group consisting of diamond, boron doped diamond and cubic boron nitride.

According to another embodiment, a polymer assisted process (“process”) for producing a superhard material-containing object having controlled spatial variations in microstructure and/or composition is provided. The process involves producing a mixture of superhard material powder with a binder. The superhard material powder has a known size and composition. The binder can include a polymer and an optional additive, such as, a plasticizer. In one or more embodiments, metal powders or ceramic powders can be added to the mixture. The mixture is hot blended and cooled to produce one or more sets/types of granules. A first set of granules comprising the superhard material-polymer binder and an option additive, is a first feedstock for producing one or more polymer filaments. A second set of granules comprises a superhard material powder, a metal or a metal alloy powder, and one or more polymer binders having an optional additive can be used as a second feedstock to make one or more polymer filaments with these constituents. Similarly, a third set of granules comprises a superhard material powder-ceramic powder-polymer binder having an optional additive can be used as a third feedstock to make one or more polymer filaments with these constituents. Thus, multiple feedstocks can be used to produce the polymer filaments. There is also a direct correlation between the type of granules and the polymer filaments that are produced by these granules. The average grain size and distribution, type and number of polymers, number of optional additives, amount of metal/metal alloy and content of metal/metal alloy can all be varied depending on the desired spatial variations in microstructure and/composition of the object. The polymer filaments (or “filaments”) can be produced by extruding the granules through a die. Each filament has a uniform size and composition. A plurality of filaments can be produced depending on the desired geometry and spatial variations in microstructure and/or composition. Using a controllable and repeatable process, such as, additive manufacturing, the polymer filaments can be deposited in a desired manner to create a printed object.

The printed object is subjected to debinding to remove the polymers and additives. During the debinding process, a predetermined amount of carbon can be intentionally left behind. The debindered object is then subjected to sintering in a high temperature/high pressure press. The sintered object can be integrally bonded to a WC-Co substrate. The resultant object, having a high percentage of the superhard material particles and including twin interconnected networks of diamond (or cubic boron nitride) and cobalt, includes the desired spatial variations in microstructure and/or composition.

Particulate diamond composites with a metal matrix where no direct bonding exists between the diamond objects are currently made using molten metal infiltration. This process is difficult to control, and only simple geometries can be made. According to another embodiment of the invention, using polymer assisted processing of a diamond-metal feedstock mix, products with complex geometries and spatial variations in composition or microstructure can be easily produced.

In yet another embodiment, polymer assisted processing can be advantageously used to produce porous boron doped diamond (BDD) electrodes either directly or by making a metal-BDD composite and then chemically removing the metallic constituent.

### BRIEF DESCRIPTION OF THE DRAWING

The invention will be described in further detail below and with reference to the attached drawings, which describe or relate to objects and processes/methods of the present invention.

FIG. 1 illustrates an exemplary flowchart showing a process for production of a superhard material-containing object in accordance with an embodiment.

FIGS. 2A-2C illustrate flowcharts depicting the steps involved in preparing one or more feedstocks, in accordance with one or more embodiments.

FIGS. 3A-3D illustrate exemplary flowcharts depicting the steps involved in preparing a printed object or other objects from feedstocks, in accordance with one or more embodiments.

FIGS. 4A-4D illustrate exemplary filaments, sheets and cylinders prepared in accordance with one or more embodiments.

FIGS. 5A-5C illustrate exemplary flowcharts depicting the steps involved in debinding the printed object or other diamond based composite object, in accordance with one or more embodiments.

FIG. 6 illustrates an exemplary flowchart depicting steps involved in debinding and sintering of a printed object, in accordance with an embodiment.

FIGS. 7A-7C and FIG. 8 illustrate exemplary embodiments of the superhard material-containing objects.

### DETAILED DESCRIPTION OF THE INVENTION

Depending on the context, all references below to the “invention” may in some cases refer to certain specific embodiments only. In other cases, it will be recognized that references to the “invention” will refer to subject matter recited in one or more, but not necessarily all, of the claims.

The present invention relates to a superhard material-containing product/article/composite object (also referred to hereinafter as “object”) that can be configured to have a controlled or predetermined three-dimensional geometry and/or shape. The object further includes a desired three-dimensional spatial variation in microstructure/rheology, grain size and/or composition. The terms “controlled” and “predetermined” are used interchangeably herein. Unlike the objects created with conventional techniques, the objects of the present invention are configured to have repeatable variations in geometry/shape, microstructure, grain size and/or composition. In one or more embodiments, the grain size range of the superhard material is 1 to 100 microns.

The present invention overcomes the lack of control on spatial variation of composition and microstructure of diamond composites (for example) using conventional techniques, such as, manual placement of starting powders. The present invention facilitates the fabrication of both simple and complex shapes with controlled spatial variations in microstructure and/or composition. Additionally, it allows the production of certain complex geometries such as case/core structures and further facilitates the creation of complex multi-layered structures.

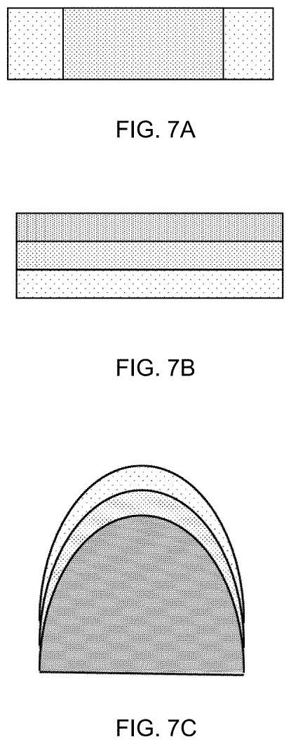

According to one or more embodiments, the objects can be configured to have varied geometries. For instance, the objects can be configured to have a single layer and no internal interfaces, multi-layer with internal interfaces that can be either planar or curved, or their external surfaces can be either planar or non-planar. Exemplary embodiments of superhard material-containing objects are shown in FIGS. 7A-7C. Particularly, FIG. 7A illustrates an exemplary diamond table with a case/core structure where the core and the case microstructures and/or compositions thereof are different from each other; FIG. 7B illustrates an exemplary three-layered diamond table having different compositions and/or microstructures across the layers; and FIG. 7C illustrates an exemplary diamond table with a more complex geometry and multiple layers with different compositions and/or microstructures. It is noted that these complex geometries having different compositions and/or microstructures cannot be easily and repeatedly produced using conventional techniques.

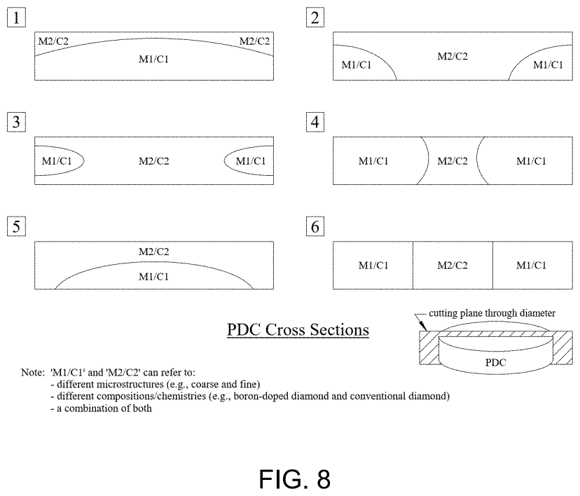

Additional embodiments of the objects are shown in FIG. 8. As shown, different microstructures (such as, coarse or fine), compositions or chemistries (such as, regular vs. boron doped diamonds), or combinations of both, can be incorporated in different parts/regions of the diamond table. These complex exemplary object profiles, as shown in FIGS. 7A-7C and FIG. 8, are nearly impossible to produce using current manual loading methods. In one or more embodiments, these object profiles can be configured to take advantage of the large difference in leaching rates between fine and coarse grain regions (fine grain regions leach much faster than coarse grain regions) to achieve a superior control over the leach profile. Additionally, in one of the profiles, where the interior is fine grain, a wire drawing die bore can be electro discharge machined with the surrounding region giving the entire assembly better fracture resistance.

In one or more embodiments, the superhard material is selected from the group consisting of diamond, boron doped diamond and cubic boron nitride (c-BN). A superhard material has a hardness (resistance to deformation when an indenter is forced into the material at a known load) exceeding 40 GPa. Only diamond and cubic boron nitride (c-BN) are known superhard materials. c-BN is more chemically resistant to attack by Fe and is used in cutting tools and grinding wheels for ferrous materials. Although the invention hereinafter is described primarily with reference to diamonds, it is understood that any superhard material can be used instead of diamonds.

According to one or more embodiments, superhard material-containing objects having complex geometries with controlled spatial variation in microstructure, grain size and/or composition can be produced using a polymer assisted process that can be carried out in a layer-wise fashion using additive manufacturing. In another embodiment, the polymer-diamond feedstock can be pre-formed into a simple shape and the preform can be green machined either in a as pressed state, or after substantially removing the polymeric binder.

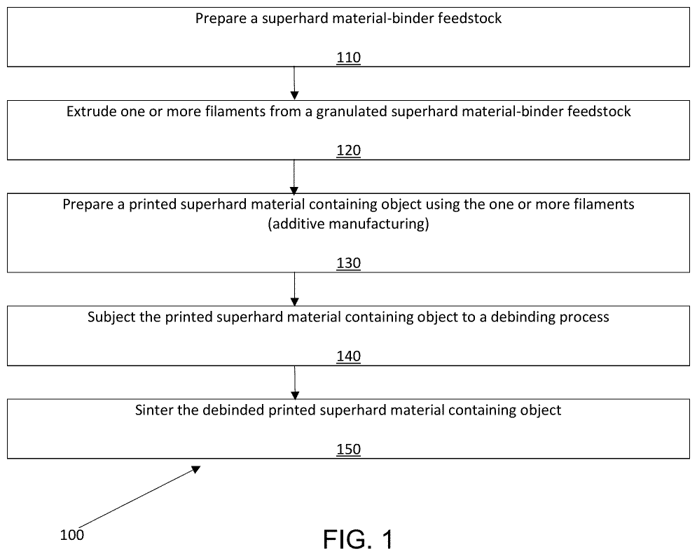

The polymer assisted process involves placement of different constituents in different locations. As shown in exemplary flowchart FIG. 1, the polymer assisted process for producing a superhard material-containing object involves the steps of: (a) in step 110, producing a feedstock of the superhard material and a polymer binder (also denoted as superhard material-polymer feedstock), and optionally, an additive; (b) in step 120, extruding one or more polymer filaments from a granulated superhard material-binder feedstock; (c) in step 130, preparing a printed superhard material-containing object (also referred to hereinafter as “printed object”) using the one or more polymer filaments; (d) in step 140, subjecting the printed object to debinding to prepare a debindered object; and (e) in step 150, sintering the debindered printed object to produce the superhard material-containing object.

In an exemplary embodiment, the superhard material-polymer feedstock can be prepared by: mixing diamond powder (for example), binder (with an additive) and optionally, a metal powder or ceramic powder to prepare a mixture; and producing granules from this mixture.

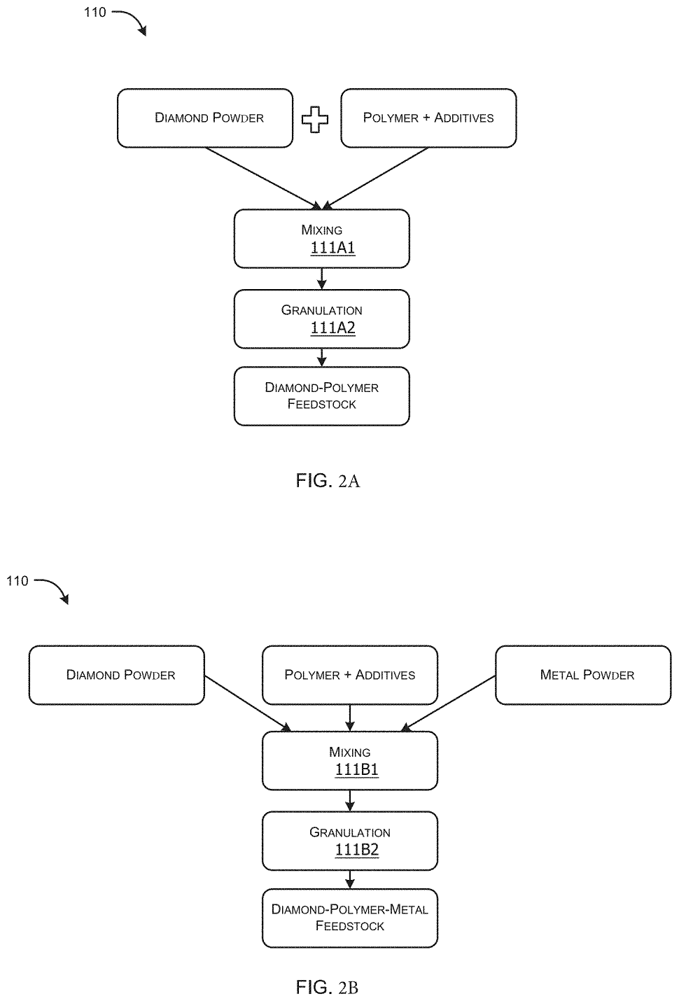

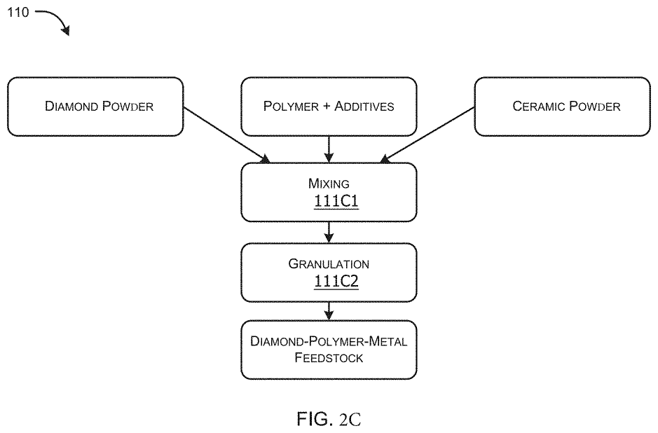

FIG. 2A illustrates an exemplary flowchart detailing the step 110 of FIG. 1 for preparing a superhard material and binder feedstock, in accordance with an embodiment of the present disclosure. As can be seen from FIG. 2A, in step 111A1, diamond powder and a binder are mixed in a defined proportion using a mixer. Any conventional mixer such as, a sigma mixer, cone mixer or a screw mixer, kneader may be used. The mixing can be carried out under heated conditions for a set amount of time. The mixing temperature and time will depend on the specific type of polymer in the binder and the amount of diamond powder. Other operating conditions may also be controlled to produce a hot mixture. The mixture is then cooled. As shown in step 111A2 (granulation), further mixing of the cooled mixture can result in the formation of a plurality of granules comprising the diamond-polymer binder feedstock. The binder may include at least one polymeric substance and optionally, one or more additives, such as, a plasticizer.

An alternate embodiment for preparing the feedstock 110 is illustrated in FIG. 2B. As shown in this flowchart, the feedstock is prepared from diamond powder, binder and a powdered form of a metal or metal compound. As can be seen from FIG. 2B, in step 111B1, diamond powder, binder and metal powder are mixed in defined proportions using a mixer. Any conventional mixer such as, a sigma mixer, cone mixer or a screw mixer, kneader may be used. The mixing can be carried out under heated conditions for a set amount of time. The mixing temperature and time will depend on the specific type of polymer in the binder and the amount of diamond powder. Other operating conditions may also be controlled to produce a hot mixture. The mixture is then cooled. As shown in step 111B2 (granulation), further mixing of the cooled mixture can result in the formation of a plurality of granules comprising the diamond-binder-metal feedstock. The binder may include at least one polymeric substance and optionally, one or more additives, such as, a plasticizer.

Yet another embodiment for preparing the feedstock 110 is illustrated in FIG. 2C. As shown in this flowchart, the feedstock is prepared from diamond powder, binder and ceramic powder. As can be seen from FIG. 2C, in step 111C1 (granulation), diamond powder, binder and ceramic powder are mixed in defined proportions using a mixer. Any conventional mixer such as, a sigma mixer, cone mixer or a screw mixer, kneader may be used. The mixing can be carried out under heated conditions for a set amount of time. The mixing temperature and time will depend on the specific type of polymer in the binder and the amount of diamond powder. Other operating conditions may also be controlled to produce a hot mixture. The mixture is then cooled. As shown in step 11C2, further mixing of the cooled mixture can result in the formation of a plurality of granules comprising the diamond-binder-ceramic feedstock. The binder may include at least one polymeric substance and optionally, one or more additives, such as, a plasticizer.

The size distribution, purity and amount of the diamond powder can be adjusted or controlled, as required, before it is mixed. Similarly, the chemistry, total amount and relative fractions of the binder can also be adjusted before it is mixed. One or more different feedstocks can be prepared depending on the profile requirements of/desired spatial variations in the microstructure and/or composition of the superhard material-containing object. The feedstocks can include, for example, diamond powders having different grain sizes, different polymers and/or plasticizers. Additionally, each feedstock can include more than one polymer or plasticizer.

The binder can be any conventional binder as known to a person skilled in the art. The binder may include at least one polymer or a polymer additive. Exemplary polymers used in the binder are Acrylonitrile Butadiene Styrene (ABS), polyethylene (PE), polylactic acid (PLA), polyamide/nylon (PA), polypropylene (PP), and other suitable polymers.

These polymers can be either amorphous such as ABS, PMMA and PS or semi-crystalline such as PA 6 and PA 12. Some polymers such as PP and PS can be either amorphous or semi-crystalline depending on the arrangement of the pendant groups. If all the pendant groups are on the same side, then the polymer is isotactic, if they are alternating, then the polymer is syndiotactic and if the arrangement is random then the polymer is atactic.

Polymer binders can also contain additives such as plasticizers, lubricants, rheology modifiers or thickeners, tackifiers and flame retardants to enhance the functional properties of the polymer. Polymers used in the one or more embodiments (as disclosed herein) contain some, but not all these additives, as described below.

Plasticizers are relatively non-volatile organic substances (mainly liquids) and when incorporated into a plastic or elastomer, they help improve the polymer's flexibility, extensibility, and processability. Plasticizers increase the flow and thermoplasticity of a polymer by decreasing the viscosity of the polymer melt, the glass transition temperature (Tg), the melting temperature (Tm) and the elastic modulus of the finished product without altering the fundamental chemical character of the plasticized material.

Plasticizers used herein depend on the specific polymer and the desired functionality. Major categories of plasticizers are phthalates, polyesters, aliphatic dibasic acid esters, terephthalates, trimellitates, benzoates and citrates. In an exemplary embodiment, the polymer used in preparing the feedstock is polyamide 12 (nylon 12) with an ester as the plasticizer. Exemplary esters used in the one or more embodiments herein include phthalate esters or acetate esters such as diethyl phthalate and glyceryl triacetate.

Lubricants are additives that improve processability of the resin and prevent damage to the molding equipment by reducing friction (external lubricants), and by lowering the bulk viscosity (internal lubricants). Typical external lubricants are metallic soaps, fatty acids, paraffin, and low molecular weight polyethylene. Silicone oils, graphite, zinc stearate, and molybdenum disulfide are often used for this purpose if the other lubricants do not provide sufficient mold release.

In one or more embodiments, both lubricants and plasticizers used to make the filaments disclosed herein. Other additives such as anti-static and anti-fogging agents can also be used in preparing the superhard material-polymer feedstock.

In an embodiment, the amount of diamond powder in the feedstock ranges from 20% to 70% by weight of the feedstock, preferably, from about 30% to about 50% by weight of the feedstock, and more preferably, from about 40% to about 50% by weight of the feedstock.

In an embodiment, the amount of binder in the feedstock ranges from about 10% to about 70% by weight of the feedstock, preferably, from about 20% to about 60% by weight of the feedstock, and more preferably, from about 25% to about 50% by weight of the feedstock. In an embodiment, the amount of the polymer in the binder ranges from about 0.1% to about 100% by weight of the binder, preferably, from about 1% to about 99% by weight of the binder, and more preferably, from about 10% to about 90% by weight of the binder. In an embodiment, the amount of plasticizer in the binder ranges from about 0% to about 50% by weight of the binder, preferably, from about 1% to about 40% by weight of the binder, and more preferably, from about 2% to about 20% by weight of the binder. In one or more embodiments, more than one plasticizer is used to prepare the feedstock. Since the densities of the polymer and plasticizer(s) are similar, their volume percentages will be similar. In an embodiment, the binder includes at least one polymeric substance and a plasticizer different from the at least one polymeric substance. In one or more embodiments, the polymers and/or the amount and nature of the polymers can be changed.

In an embodiment, the amount of metal (or metal compounds/alloys) powder in the feedstock is relatively small. It can range from about 0% to about 50% by weight of the feedstock, preferably, from about 2% to about 45% by weight of the feedstock, and more preferably, from about 5% to about 40% by weight of the feedstock. In one or more embodiments, the metal can be Ni, Co or Fe or alloys thereof. In one or more embodiments, changes in refractory metal and compound additions such as Ti, Zr, Hf, V, Nb, Ta, Cr, Mo and W and carbides and nitrides of one or more of these elements can be introduced to produce a superhard material-containing object having desired variations in microstructure and/or composition.

In an embodiment, the amount of ceramic powder in the feedstock ranges from about 0% to about 50% by weight of the feedstock, preferably, from about 2% to about 45% by weight of the feedstock, and more preferably, from about 5% to about 40% by weight of the feedstock.

The granulated superhard material-polymer binder feedstock (with or without additives/metal/ceramic powders) are extruded through a die to produce one or more polymer filaments (step 120, FIG. 1). Extrusion is a conventional process where a material undergoes plastic deformation by the application of a force causing that material to flow through an orifice or die. The polymer filaments can be used in an additive manufacturing system to produce a printed (or a 3D-printed) object (step 130, FIG. 1). As used herein, the term “printed superhard material-containing object” (or “printed object”) refers to a 3D printed superhard material-containing object that includes a polymer binder.

Alternately, in lieu of extrusion, the granulated superhard material-polymer binder feedstock can be rolled to form a sheet and then subjected to machining to form a diamond based composite object. The granulated superhard material-polymer binder feedstock can also be pressed to form simplistic shapes which can be machined to form a diamond based composite object. The granulated superhard material-polymer binder feedstock can also be subjected to injection molding to form slightly more complex diamond based composite objects. The diamond based composite is any of a polycrystalline diamond composite (PDC), a particulate diamond composite (DPC), a diamond-ceramic composite and a porous boron doped diamond (BDD) electrode.

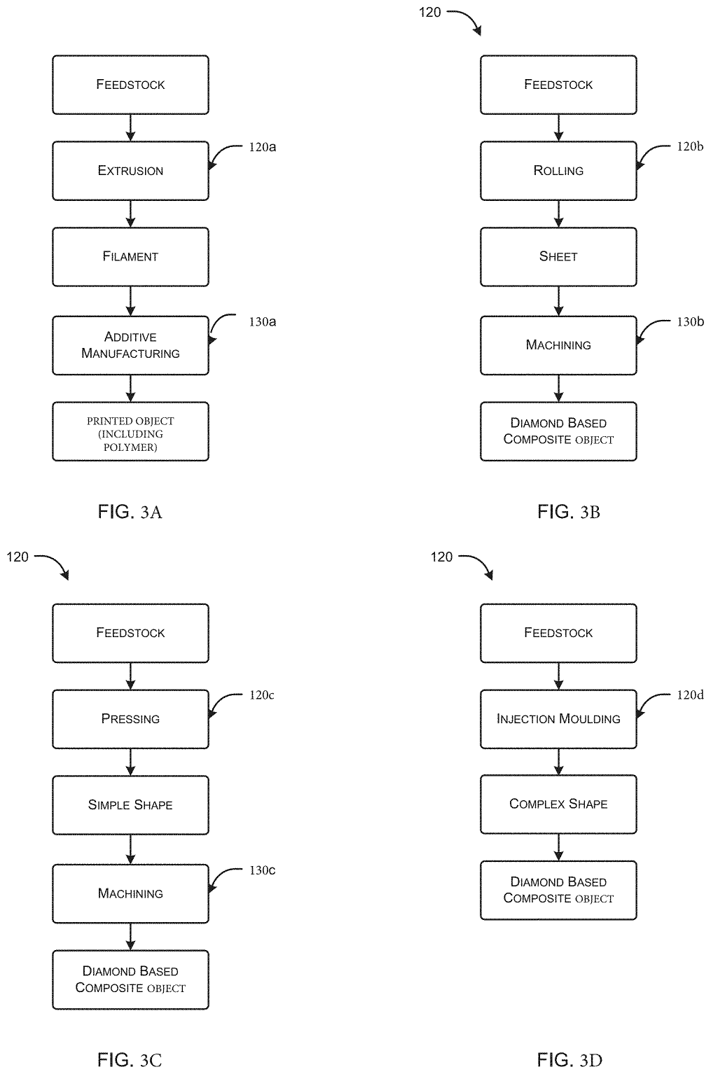

FIG. 3A details of the steps 120 and 130 for preparing the printed object from the granulated superhard material-polymer binder feedstock. As can be seen from FIG. 3A, in step 120a, the feedstock is subjected to extrusion to prepare one or more polymer filaments. The filaments are deposited in a controlled manner using additive manufacturing (step 130a) to prepare a 3D-printed (or “printed”) object. Additive manufacturing uses data from computer-aided-design (CAD) software or 3D object scanners to direct hardware to deposit material, layer upon layer, in precise geometric shapes. As its name implies, additive manufacturing adds material to create a printed object. By contrast, when you create an object by traditional/conventional means, it is often necessary to remove material through milling, machining, carving, shaping or other means. Additive manufacturing is also known as 3D printing or rapid prototyping.

In an embodiment, the filament is subjected to additive manufacturing process in a Fused filament fabrication (FFF) machine to prepare a printed object (such as, a diamond based composite object) of desired geometry. Fused filament fabrication is a 3D printing process that uses a continuous filament of thermoplastic material, or a mixture of thermoplastic material and other constituents fed through a heated printer extruder head and deposited to form layers. Typically, the extruder head moves in two dimensions, creating one layer at a time before adjusting vertically to begin a new layer.

It should be appreciated that a plurality of filaments can also be used in the FFF machine to produce geometries with desired variations. The total number of filaments is directly dependent on the desired spatial three-dimensional composition/microstructure variation(s). For instance, if a superhard material-containing object having two different regions is required, such as in case/core or layered geometries (either planar or non-planar), then two different filaments are required and produced and if three different regions are desired, three filaments are required and produced, and so on. That is, there is a one-to-one correspondence between the number of regions in the superhard material-containing object and the number of filaments. The filaments are deposited layer by layer under the control of a program that starts and stops deposition of a first layer before it switches to a second one. The process can be paused and resumed, as required, to create the desired profiles.

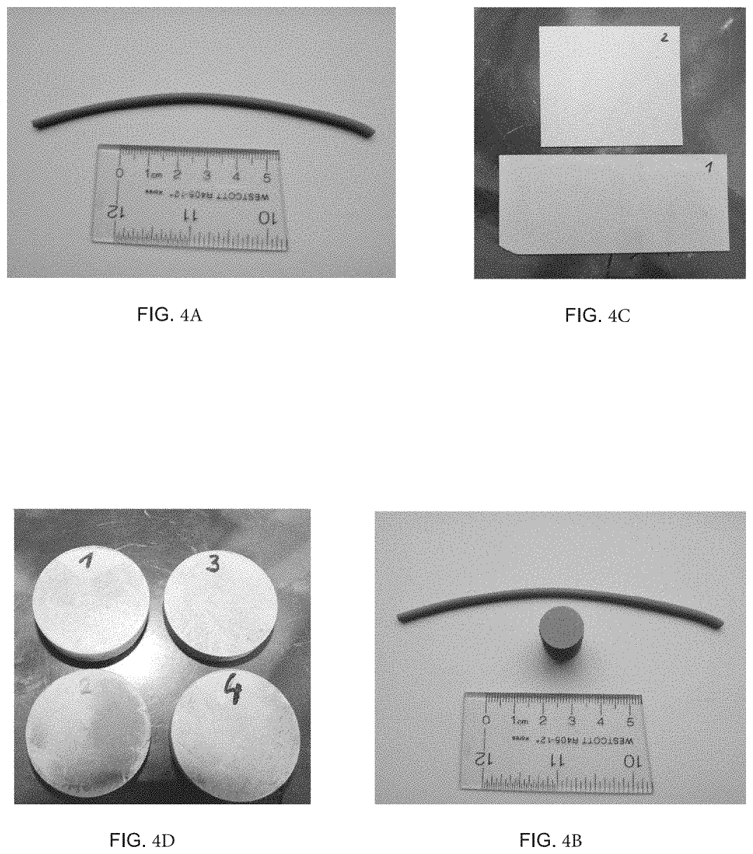

FIG. 4A illustrates an exemplary image showing a polymer filament prepared in accordance with this embodiment. FIG. 4B illustrates an exemplary cylindrical shaped printed object produced by processing the filament in the Fused Filament Fabrication (FFF) machine in accordance with this embodiment.

FIG. 3B illustrates an exemplary flow chart showing details of the step 120 for preparing a diamond based composite object from the granulated superhard material-polymer binder feedstock according to another embodiment. As can be seen from FIG. 3B, in step 120b, the feedstock is subjected to rolling to prepare one or more sheets. The sheets may then be subjected to machining (step 130b) to prepare the diamond based composite object. FIG. 4C illustrates exemplary sheets prepared in accordance with this embodiment.

FIG. 3C illustrates an exemplary flow chart showing details of the step 120 for preparing a diamond based composite object from the granulated superhard material-polymer binder feedstock according to yet another embodiment. As can be seen from FIG. 3C, in step 120c, the feedstock is subjected to pressing, such as warm pressing, to prepare an object having a simple shape. The shaped object may then be subjected to machining (step 130c) to prepare the diamond based composite object. FIG. 4D illustrates exemplary cylinders prepared in accordance with this embodiment.

FIG. 3D illustrates an exemplary flow chart showing details of the step 120 for preparing a diamond based composite object from the granulated superhard material-polymer binder feedstock according to yet another embodiment. As can be seen from FIG. 3D, in step 120d, the feedstock is subjected to injection molding to prepare a diamond based composite object having a more complex shape/geometry.

In yet another embodiment, the object can be made by any or a combination of an additive manufacturing process, a machining process, and an injection molding process.

The printed object is next subjected to a debinding process, as shown in Step 140 of FIG. 1. Debinding processes are used to remove one or more constituents from the printed object or the injection molded diamond composite object using either chemical or thermal processes. During debinding, the constituents are removed sequentially to retain the fabricated geometry and create open pores that facilitate removal of other constituents. In one or more embodiments, the printed object is subjected to substantial debinding that leaves a desired amount of residual carbon in the debindered printed object. Debinding of the printed object is carried out such that any residual carbon left from the binder may be sufficient enough to preserve any or a combination of: (a) geometry of the debindered object, and (b) spatial variations in structure of the debindered object. The debinding step can further involve: (i) effecting removal of the plasticizer from the printed object using a solvent; and (ii) effecting substantial removal of the polymer to prepare the debindered printed object.

In yet another embodiment, the step of subjecting the printed object to debinding includes: (i) effecting a thermal debinding of the printed object in a reactive atmosphere to substantially remove the binder therefrom; and (ii) subjecting the object to a second/subsequent debinding step wherein at least a residual amount of carbon is left in the debindered object, wherein the second debinding step is conducted in a non-reactive atmosphere to leave the residual carbon in the debindered object. Typical debinding temperatures are in the range of 450° C. Thermal debinding can begin at about 200° C. and ends at about 500° C. This range can vary depending on the type of polymer used in the binder. The plasticizer is typically removed before thermal debinding using a solvent at slightly elevated temperature, about 50° C.

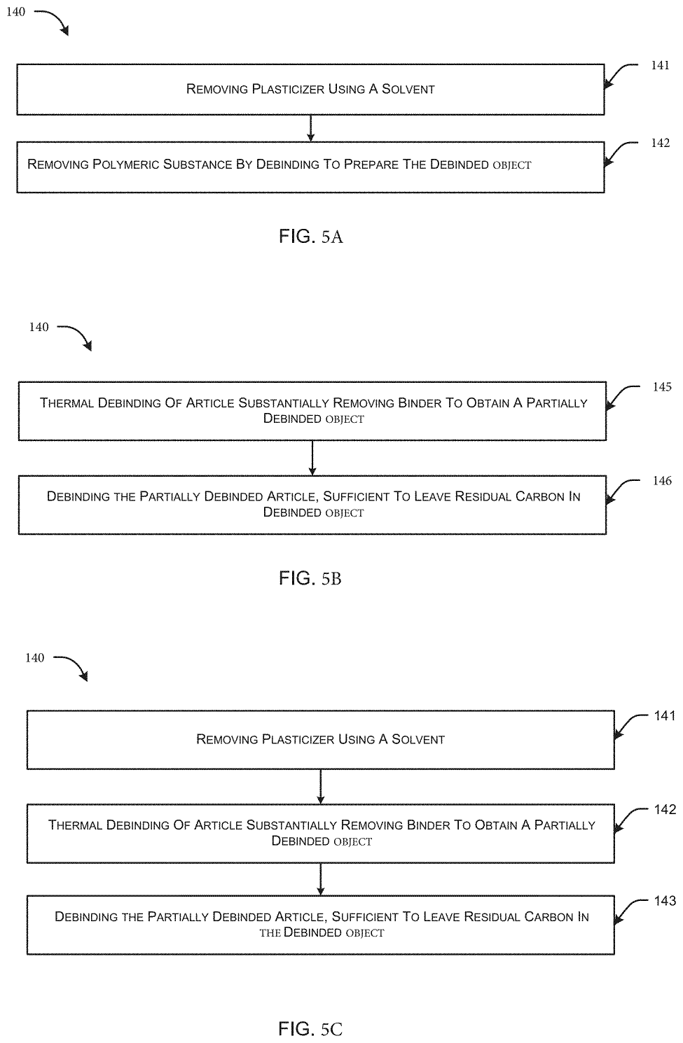

FIG. 5A-5C illustrate exemplary flowcharts depicting details of the step 140 (as shown in FIG. 1) for debinding the printed object in accordance with one or more embodiments of the present disclosure.

As can be seen from FIG. 5A, in accordance with an embodiment, where the binder includes at least one polymeric substance and a plasticizer, the step 140 of subjecting the printed object to debinding may include: in step 141, effecting removal of the plasticizer using a solvent; and in step 142, effecting removal of the polymer by debinding to prepare the debindered object.

The inventor observed that it was advantageous, during the debinding step, to leave a desired amount of residual carbon in the debindered object, as complete removal of the polymer binder could result in shape instability. Accordingly, in or more embodiments, the debinding process is not taken to completion but a carbon residue is intentionally left behind in the debindered object. The residual amount of carbon can range from about 0.1% to 45%, preferably, ranging from about 0.1% to 40%, more preferably, ranging from about 0.1% to 30% and most preferably, ranging from about 0.1% to 25%. The residual carbon, left in the debindered object, can advantageously be converted to the diamond phase (for instance) during the sintering step leaving only the diamond (or superhard material) composite or a diamond-metal composite, as detailed below.

As can be seen from FIG. 5B, in accordance with another embodiment, the step 140 of subjecting the printed object to debinding may include: in step 145, effecting thermal debinding of the printed object to substantially remove the binder and obtain a partially debindered object; and in step 146, subjecting the partially debindered object to further debinding to obtain the debindered object, leaving behind some residual carbon in the debindered object.

As can be seen from FIG. 5C, in accordance with yet another embodiment, where the binder includes at least one polymer and a plasticizer, the step 140 of subjecting the printed object to debinding may include: in step 141, effecting removal of the plasticizer using a solvent; in step 142, effecting thermal debinding of the object to substantially remove the binder and to obtain a partially debindered object; and in step 143, subjecting the partially debindered object to further debinding to obtain the debindered object, leaving behind some residual carbon in the debindered object.

In yet another embodiment, the step of subjecting the printed object to debinding includes subjecting the printed object to a catalytic debinding to effect substantial removal of the binder from the object.

Although the debinding process is described herein with reference to the 3D-printed object, it is understood that it can also be used in connection with the diamond based composite object that is produced using rolling, pressing or injection molding (as described in FIGS. 3B-3D).

As shown in Step 150 of FIG. 1, the debindered object is subjected to sintering. Sintering is a thermal process of converting loose fine particles into a solid coherent mass by heat and/or pressure without fully melting the particles to the point of melting. In one or more embodiments, the step of sintering the debindered object involves subjecting the debindered object to any or a combination of: a high pressure high temperature (HPHT) process, vacuum sintering and inert gas sintering. The sintered object can then be integrally bonded to a WC-Co substrate in a high temperature/high pressure process where Co from the WC-Co will infiltrate the diamond network and form diamond-cobalt bonds.

In one embodiment, the step of subjecting the debindered object to sintering includes: subjecting the debindered object to a pressure and a temperature, sufficient to effect, at least in part, conversion of the residual carbon to a diamond phase.

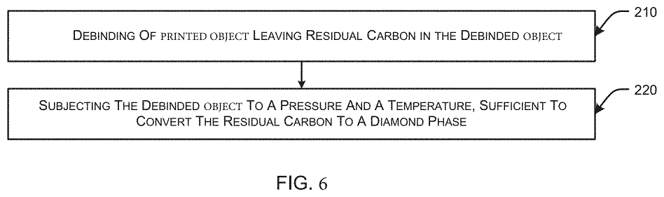

FIG. 6 illustrates an exemplary flowchart depicting a process for debinding and sintering a printed object made from a diamond powder, a binder and optionally, any of a metal powder and a ceramic powder in accordance with an embodiment of the present disclosure. As can be seen from FIG. 6, the process includes: in step 210, effecting debinding of the object, leaving a residual carbon from the binder, to produce a debindered object; and in step 212, subjecting the debindered object to a pressure and a temperature, sufficient to effect, at least in part, to convert the residual carbon to a diamond phase, to produce the debindered and sintered object. The debindered and sintered object is also known as the superhard material-containing object in accordance with the one or more embodiments of the invention.

For diamond based composites, where diamond-diamond bonding is required, such as in polycrystalline diamond (PCD) cutters, porous boron doped diamond based electrodes and the like, it is advantageous to subject the debindered diamond based composite object to pressure and temperature conditions sufficient to convert the residual carbon to a diamond phase, for example, using high pressure high temperature (HPHT) process. The pressure and temperature conditions at which the residual carbon converts to a diamond phase is well known to persons skilled in the art and are not detailed herein. In alternative embodiments, wherein formation of diamond-diamond bonding is not required, for example, in particulate diamond composites (DPC), the debindered diamond based composite object can be subjected to conventional sintering techniques such as vacuum sintering, inert gas sintering and the like to produce the diamond based composite. Accordingly, wide varieties of diamond based composites of desired geometries and/or compositions can easily be produced by the advantageous process of the present disclosure.

In an exemplary embodiment, a process for debinding and sintering of a printed object made from a diamond powder, a binder and optionally, any of a metal powder and a ceramic powder includes the steps of: (i) effecting debinding of the object, leaving a residual carbon from the binder, thereby producing a debindered object; and (ii) subjecting the debindered object to a pressure and a temperature, sufficient to effect, at least in part, conversion of the residual carbon to a diamond phase, to produce the debindered and sintered object. In an embodiment, the debindered and sintered object has diamond-diamond bonding in its microstructure.

Diamond-SiC ceramic composites are used in a variety of applications where high hardness, wear resistance and good thermal conductivity are required. In fixed cutters drill bits, Diamond-SiC inserts are used in high wear areas to improve wear resistance. These composites can be produced by HPHT processing of Diamond-Si mixtures or by using low-pressure methods such as liquid or vapor infiltration of a diamond preform in a non-oxidizing environment to prevent thermal degradation of diamond to graphite. Diamond-nano SiC composites can be produced by HPHT processing of ball-milled diamond and amorphous Si powder mixtures. The nanocrystalline structure of the SiC matrix increases the fracture resistance of the composite. Diamond-SiC composites have also been produced by reactive melt infiltration of a diamond preform made by stereo lithography.

The one or more embodiments for producing a superhard material-containing object can also be applied to fabrication of diamond-SiC or other diamond-ceramic composites. In this embodiment, required powder mixtures can be incorporated into a blend a desired feedstock can be made from this blend. The feedstock can then be processed into any desired shape using a FFF additive manufacturing machine for complex shapes and simpler sheets and cylinders for simple shapes.

In an exemplary embodiment, the diamond powder (used to prepare the feedstock) includes a powder of polycrystalline diamond. In an embodiment, the superhard material-containing object is a diamond based composite. In another embodiment, the superhard material-containing object is a polycrystalline diamond composite (PDC).

In one or more embodiments, the diamond particle size distribution can be intentionally altered to increase the diamond content of the feedstock to minimize the amount of polymer used and the amount that needs to be removed in the first and second debinding stages.

Thermal management is critical for reliability and long-life of high-power laser diode and LED packages. Diamond with its very high thermal conductivity is currently being considered for this application. In addition to thermal conductivity, it is also necessary to match the coefficient of thermal expansion to semiconductors, typically 4 to 7 ppm/K. Diamond/metal composites as well as the Diamond-SiC composites are viable candidates for this application. Currently, molten metal infiltration is being used for producing such composites. This process is conducted under conditions where the thermal stability of diamond might be compromised. The process is expensive and the types of part geometries that can be produced are limited. Using the one or more embodiments described herein, diamond powders and metal powders made from Cu, Ag and Au alloys can be blended with a polymer blend, hot mixed and granulated to produce a feedstock. This feedstock can also contain alloy powders such as Cu—Ti, Ag—Ti and Au—Ti for enhanced bonding of the metal matrix to the diamond particles. This feedstock can then be fabricated into either a filament, disc or plate as described herein. The fabricated shapes can be subjected to debinding followed by vacuum sintering at a temperature high enough to achieve high final density while not thermally degrading the diamond particles.

In an embodiment, the superhard material-containing object is a porous boron doped diamond (BDD) electrode. Diamond is good thermal conductor but an electrical insulator. It can be made electrically conductive by doping with boron. BDD electrodes have received considerable scientific and research interest due to their very high over voltage and a broad operating window for electrochemical reactions. Many reactions that are precluded on noble metal or other electrodes can occur with BDD electrodes. Currently BDD electrodes come in two flavors: thin films made by chemical vapor deposition (CVD) where the boron is incorporated from the gas phase as diboromethane or by incorporating BDD grit particles grown by HPHT process into a polymeric sheet. The CVD electrodes are expensive, and the polymeric electrode can only be made in sheets. A porous BDD electrode with a large surface area and sufficient mechanical strength will be of great interest. The methods discussed herein can be applied using BDD containing feedstock to produce complex electrode geometries. The boron concentration may be in the range of 500 to 10,000 ppm. The fabricated shape can be debindered and then subject to a HTHP process to produce a diamond/metal composite with diamond/diamond bonds. The metal component from the resulting composite can be leached to produce a highly porous but strong electrode with unlimited freedom of geometry. If a small amount of polymer can be left in place, a complex BDD electrode can be produced without the requirement for HPHT process.

The superhard material-containing object described herein can be used as cutters for oil and gas drilling, wires for drawing dies and enhanced inserts for mining. Boron Doped Diamond electrodes can be used for water treatment and purification and for in vivo and in vitro use for electrical stimulation and neurochemical and other identification and quantification.

The particular illustrative embodiments disclosed above may be altered or modified and all such variations are considered within the scope and spirit of the present invention. While the process or the object is described in terms of “comprising”, “containing” or “including” various components or steps, it is understood that the process or object can also “consist essentially of” or “consist of” the various components and steps. Whenever a numerical range with a lower limit and an upper limit is disclosed, any number and any included range that falls within the range is also specifically disclosed. As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and can include the steps and elements of the present invention and do not exclude other steos or elements described herein. The use of the word “a” or “an” when used in conjunction with the term “comprising” in the claims and/or the specification may mean “one,” but it is also consistent with the meaning of “one or more,” “at least one,” and “one or more than one.”

The term and phrases “invention,” “present invention,” “instant invention,” “disclosure”, and similar terms and phrases as used herein are non-limiting and are not intended to limit the present subject matter to any single embodiment, but rather encompass all possible embodiments as described.

All ranges recited herein include the endpoints, including those that recite a range “between” two values. Terms such as “about,” “generally,” “substantially,” and the like are to be construed as modifying a term or value such that it is not an absolute. Such terms will be defined by the circumstances and the terms that they modify as those terms are understood by those of skill in the art. In one non-limiting embodiment, the terms are defined to be within 5%. The term “substantially” and its variations are defined as being largely but not necessarily wholly what is specified as understood by one of ordinary skill in the art.

1. An object comprising:
a superhard material, wherein the superhard material is selected from the group consisting of diamond, boron doped diamond and cubic boron nitride,
wherein the object is configured with one or more controlled or predetermined spatial variations in microstructure and/or composition.

2. The object according to claim 1, wherein the object has a predetermined and repeatable geometry and/or shape.

3. The object according to claim 1, wherein the spatial variations are configured by a controlled layer-by-layer deposition of one or more polymer filaments using an additive manufacturing process.

4. The object according to claim 3, wherein each of the polymer filaments has a uniform size and composition.

5. The object according to claim 3, wherein each of the polymer filaments is extruded from one or more sets of granules.

6. The object according to claim 3, wherein the object comprises at least a first region and a second region, and wherein the first region and the second region have dissimilar microstructures and/or compositions.

7. The object according to claim 6, wherein a first polymer filament is associated with formation of the first region and wherein a second polymer filament is associated with formation of the second region.

8. The object according to claim 7, wherein the first polymer filament comprises a first feedstock and wherein the second polymer filament comprises a second feedstock.

9. The object according to claim 8, wherein the first and second feedstocks vary in at least one of: an average grain size and distribution, a polymer binder, an optional additive, number of optional additives, amount of metal/metal alloy and content of metal/metal alloy.

10. The object according to claim 1, wherein the object comprises a substantially debindered and sintered 3D-printed object integrally bonded to a WC-Co substrate.

11. The object according to claim 1, wherein the concentration of boron in the superhard material is in the range of 500 to 10,000 ppm.

12. A method of preparing a superhard material-containing object, comprising:
producing an object having controlled spatial variations in microstructure and/or composition;
substantially debinding the object; and
sintering and integrally bonding the substantially debindered object to a WC-Co substrate by a high pressure high temperature (HPHT) process to produce the superhard material-containing object,
wherein the superhard material is selected from the group consisting of a diamond, boron doped diamond and cubic boron nitride.

13. The method according to claim 12, wherein the superhard material-containing object has a predetermined and repeatable geometry and/or shape.

14. The method according to claim 12, further comprising producing the spatial variations in microstructure and/or composition by a controlled layer-by-layer deposition of one or more polymer filaments using an additive manufacturing process.

15. The method according to claim 12, wherein the superhard material-containing object comprises at least a first region and a second region, and wherein the first region and the second region have dissimilar spatial microstructures and/or compositions.

16. The method according to claim 15, wherein a first filament is associated with formation of the first region, wherein a second filament is associated with formation of the second region, and wherein the first and the second filaments are formed from different feedstocks.

17. The method according to claim 14, further comprising producing the one or more polymer filaments by an extrusion process involving one or more sets of granules, each set of granules formed from a different feedstock.

18. The method according to claim 17, wherein at least one set of granules is prepared by hot mixing and cooling a mixture comprising a superhard material powder and a polymer binder having one or more optional additives.

19. The method according to claim 18, wherein the additive includes one or more plasticizers.

20. The method according to claim 18, wherein the amount of the polymer in the binder ranges from about 0.1% to about 100% by weight of the binder.

21. The method according to claim 19, wherein the amount of plasticizer in the binder ranges from about 0% to about 50% by weight of the binder.

22. The method according to claim 12, wherein the step of debinding the object involves a first debinding step to remove a large portion of the binder.

23. The method according to claim 22, wherein the step of debinding the printed object involves a second debinding step, and wherein in the second debinding step, a residual amount of carbon is intentionally left behind to preserve or obtain the predetermined geometry and spatial variations in microstructure and/or composition.

24. The method according to claim 23, wherein the residual amount of carbon ranges from 0.1% to 25%.

25. The method according to claim 23, wherein the residual carbon is converted to a diamond phase during the sintering step.
